(19) United States
(12) Patent Application Publication
(10) Pub. No.: US 2021/0292648 A1
(43) Pub. Date: Sep. 23, 2021

(54) COMPOSITIONS RESISTANT TO DISCOLORATION

(71) Applicant: DAP Products Inc., Baltimore, MD (US)

(72) Inventor: Jenny Donoghue, Baltimore, MD (US)

(21) Appl. No.: 17/204,466

(22) Filed: Mar. 17, 2021

Related U.S. Application Data
(60) Provisional application No. 62/991,826, filed on Mar. 19, 2020.

(51) Int. Cl. C09K 15/04; C09D 11/037; B41M 7/00

(52) U.S. Cl. CPC C09K 15/04; B41M 7/0036; C09D 11/037

(57) ABSTRACT

Described herein are compositions that are resistant to discoloration. Also described herein are methods of formulating a colorant component useful for producing a composition resistant to discoloration and methods of producing compositions that are resistant to discoloration.

### CROSS-REFERENCE TO RELATED APPLICATIONS

This application claims priority to U.S. Provisional Application Ser. No. 62/991,826, filed on Mar. 19, 2020, the content of which is hereby incorporated by reference in its entirety.

### FIELD OF DISCLOSURE

This disclosure is directed to compositions that are resistant to discoloration. This disclosure is also directed to methods of formulating a colorant component useful for producing a composition resistant to discoloration and methods of producing compositions that are resistant to discoloration. Compositions and methods in accordance with the present disclosure are useful in a variety of products that are susceptible to discoloration.

### BACKGROUND

Pigmented and clear products are prone to discoloration over time. Discolored products are aesthetically unpleasant and undesirable.

The most common type of discoloration is yellowing. Conventionally, a blue colorant has been added to products prone to yellowing. However, this technique only replaces yellowing discoloration with green discoloration.

The present disclosure provides compositions that are resistant to discoloration. The resistance to discoloration of these compositions is tunable depending on the observed processes effecting discoloration. The methods of the present disclosure are broadly applicable to a variety of compositions susceptible to discoloration.

### BRIEF DESCRIPTION OF THE DISCLOSURE

In one aspect, provided herein is a composition resistant to discoloration, the composition comprising
a component susceptible to discoloration; and
a colorant component characterized by a three-dimensional color space that is complementary to the differences between a first three-dimensional color space of a reference component susceptible to discoloration and a second three-dimensional color space of the reference component susceptible to discoloration, wherein the second three-dimensional color space has been shifted from the first three-dimensional color space by a process effecting discoloration.

In another aspect, provided herein is a method of formulating a colorant component useful for producing a composition resistant to discoloration, the method comprising
measuring a reference three-dimensional color space of a reference component susceptible to discoloration;
effecting a shift in the reference three-dimensional color space of the reference component susceptible to discoloration;
measuring the shifted three-dimensional color space of the reference component susceptible to discoloration;
calculating the differences between the reference three-dimensional color space of the reference component susceptible to discoloration and the shifted three-dimensional color space of the reference component susceptible to discoloration;
calculating a three-dimensional color space complementary to the differences between the reference three-dimensional color space of the reference component susceptible to discoloration and the shifted three-dimensional color space of the reference component susceptible to discoloration; and
formulating a colorant component characterized by the three-dimensional color space complementary to the differences between the reference three-dimensional color space of the reference component susceptible to discoloration and the shifted three-dimensional color space of the reference component susceptible to discoloration.

In yet another aspect, provided herein is a method of producing a composition resistant to discoloration, the method comprising forming a mixture comprising
a component susceptible to discoloration; and
a colorant component characterized by a three-dimensional color space that is complementary to the differences between a first three-dimensional color space of a reference component susceptible to discoloration and a second three-dimensional color space of the reference component susceptible to discoloration, wherein the second three-dimensional color space has been shifted from the first three-dimensional color space by a process effecting discoloration.

### BRIEF DESCRIPTION OF THE DRAWINGS

FIG. 1 is a graphical depiction of an exemplary embodiment of a three-dimensional color space in accordance with the present disclosure.

FIG. 2 is a graphical depiction of an exemplary embodiment of a white sealant composition in accordance with the present disclosure that exhibits resistance to discoloration.

FIG. 3 is a graphical depiction of an exemplary embodiment of a clear sealant composition in accordance with the present disclosure that exhibits resistance to discoloration.

### DETAILED DESCRIPTION OF THE DRAWINGS

The figures are examples of compositions in accordance with the present disclosure and are not to be construed as limiting.

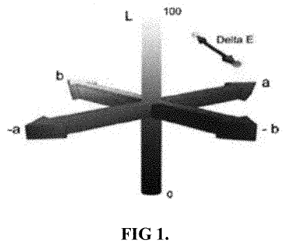

The exemplary embodiment of FIG. 1 depicts a three-dimensional color space. The b axis is the yellow blue axis, the a axis is the red green axis, and the L axis is the black white axis. Delta E is a complimentary three-dimensional color space vector represented by Formula 1:

ΔE=\sqrt{(Lᵢ*−Lₓ*)²+(aᵢ−aₓ)²+(bᵢ*−bₓ*)²} (Formula 1),

where i is the initial color variable and x is the color variable after exposure.

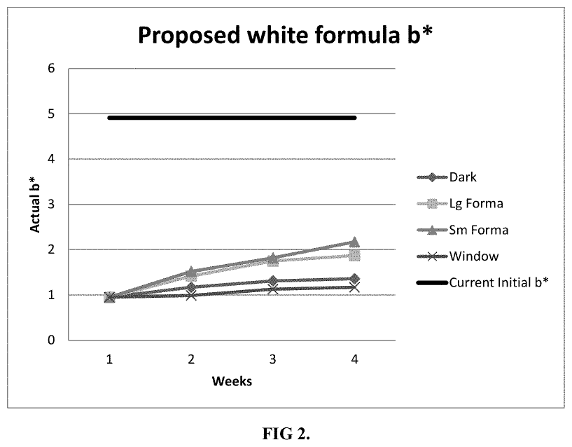

The exemplary embodiment of FIG. 2 was obtained by exposing four different white sealant compositions to varying conditions of environmental exposure for a total of four weeks. This exemplary embodiment demonstrates that pigmented compositions in accordance with the present disclosure resist discoloration, and in particular yellowing, across a variety of experimental conditions.

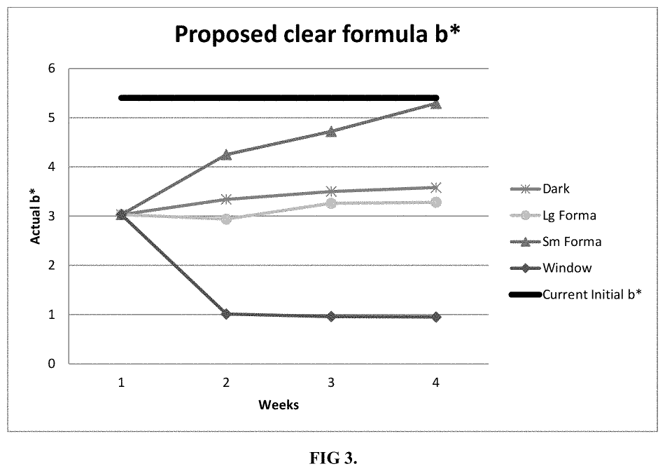

The exemplary embodiment of FIG. 3 was obtained by exposing four different clear sealant compositions to varying conditions of environmental exposure for a total of four weeks. This exemplary embodiment demonstrates that colorless compositions in accordance with the present disclosure resist discoloration, and in particular yellowing, across a variety of experimental conditions.

### DETAILED DESCRIPTION OF THE DISCLOSURE

Compositions in accordance with the present disclosure are resistant to discoloration and comprise a component susceptible to discoloration and a colorant component characterized by a three-dimensional color space that is complementary to the differences between a first three-dimensional color space of a reference component susceptible to discoloration and a second three-dimensional color space of the reference component susceptible to discoloration, wherein the second three-dimensional color space has been shifted from the first three-dimensional color space by a process effecting discoloration.

In some embodiments, the component susceptible to discoloration is colorless. In some embodiments, the component susceptible to discoloration is pigmented. In some embodiments, the component susceptible to discoloration comprises a color selected from white, black, gray, red, orange, yellow, green, blue, purple, violet, and any combination thereof. In some embodiments, the component susceptible to discoloration comprises at least two colors selected from white, black, gray, red, orange, yellow, green, blue, purple, violet, and any combination thereof. In some embodiments, the component susceptible to discoloration comprises at least three colors selected from white, black, gray, red, orange, yellow, green, blue, purple, violet, and any combination thereof.

In some other embodiments, the component susceptible to discoloration is opaque, translucent, or clear. In some embodiments, the component susceptible to discoloration is opaque. In some embodiments, the component susceptible to discoloration is clear.

In yet other embodiments, the component susceptible to discoloration is a curable composition. In some embodiments, the component susceptible to discoloration is a construction product. In some embodiments, the component susceptible to discoloration is selected from the group consisting of sealants, caulks, adhesives, paints, coatings, and combinations thereof.

In other embodiments, the component susceptible to discoloration comprises a polymer selected from polyurethane, polyurea, polyacrylate, polyether, polyether-based silane-terminated polymer, and combinations thereof.

In some embodiments, the colorant component comprises a colorant selected from dyes, pigments, and combinations thereof. In some embodiments, the chemical identity of the colorant is immaterial provided that the colorant is characterized by a three-dimensional color space that is complementary to the differences between a first three-dimensional color space of a reference component susceptible to discoloration and a second three-dimensional color space of the reference component susceptible to discoloration, wherein the second three-dimensional color space has been shifted from the first three-dimensional color space by a process effecting discoloration.

In some embodiments, the colorant component comprises a colorant in a form selected from solids, powders, granules, liquids, oils, and aqueous solutions. In some embodiments, the colorant component comprises a hydrophobic colorant. In some embodiments, the colorant component comprises a hydrophilic colorant.

In some embodiments, the colorant component comprises a color selected from white, black, gray, red, orange, yellow, green, blue, purple, violet, and any combination thereof. In some embodiments, the colorant component comprises at least two colors selected from white, black, gray, red, orange, yellow, green, blue, purple, violet, and any combination thereof. In some embodiments, the colorant component comprises at least three colors selected from white, black, gray, red, orange, yellow, green, blue, purple, violet, and any combination thereof.

In some embodiments, the colorant component comprises a colorant selected from a violet colorant, a black colorant, and combinations thereof. In some embodiments, the colorant component does not comprise a blue colorant.

In some embodiments, the colorant component comprises Macrolex® Violet B, Macrolex® Violet B Gran, or a combination thereof. Macrolex® Violet B Gran is a solvent soluble dye that can either be adding directly as a powder or diluted into a solvent and added during compounding.

In some embodiments, the three-dimensional color space of the colorant component has a non-zero value in only one dimension. In some embodiments, the three-dimensional color space of the colorant component has non-zero values in at least two dimensions. In some embodiments, the three-dimensional color space of the colorant component has non-zero values in three dimensions.

In some embodiments, the three-dimensional color space that is complementary to the differences between a first three-dimensional color space of a reference component susceptible to discoloration and a second three-dimensional color space of the reference component susceptible to discoloration is 100% complimentary to the differences between a first three-dimensional color space of a reference component susceptible to discoloration and a second three-dimensional color space of the reference component susceptible to discoloration. In some embodiments, the three-dimensional color space that is complementary to the differences between a first three-dimensional color space of a reference component susceptible to discoloration and a second three-dimensional color space of the reference component susceptible to discoloration is greater than about 95% complimentary to the differences between a first three-dimensional color space of a reference component susceptible to discoloration and a second three-dimensional color space of the reference component susceptible to discoloration. In some embodiments, the three-dimensional color space that is complementary to the differences between a first three-dimensional color space of a reference component susceptible to discoloration and a second three-dimensional color space of the reference component susceptible to discoloration is greater than about 90% complimentary to the differences between a first three-dimensional color space of a reference component susceptible to discoloration and a second three-dimensional color space of the reference component susceptible to discoloration. In some embodiments, the three-dimensional color space that is complementary to the differences between a first three-dimensional color space of a reference component susceptible to discoloration and a second three-dimensional color space of the reference component susceptible to discoloration is greater than about 80% complimentary to the differences between a first three-dimensional color space of a reference component susceptible to discoloration and a second three-dimensional color space of the reference component susceptible to discoloration.

In some embodiments, the process effecting discoloration is effected for a single reference component. In some embodiments, the process effecting discoloration is effected for a plurality of reference components.

In some embodiments, the reference component susceptible to discoloration is a sample of the component susceptible to discoloration. In some embodiments, the reference component susceptible to discoloration is a sample from a different batch of the component susceptible to discoloration. In some embodiments, the reference component susceptible to discoloration is a sample from the same batch as the component susceptible to discoloration.

In some embodiments, the process effecting discoloration effects discoloration in only one dimension of the three-dimensional color space. In some embodiments, the process effecting discoloration effects discoloration in at least two dimensions of the three-dimensional color space. In some embodiments, the process effecting discoloration effects discoloration in three dimensions of the three-dimensional color space.

In some embodiments, the process effecting discoloration occurs in innate conditions without exposure to an abnormal environmental condition. Innate conditions are natural conditions such as room temperature and ambient light and humidity. In some embodiments, the process effecting discoloration comprises exposing the component susceptible to discoloration to an environmental condition selected from the group consisting of light, heat, humidity, age, and combinations thereof. In some embodiments, exposure to an environmental condition includes exposure to low, intermediate, or high values of that condition. In some embodiments, the environmental conditions are natural, synthetic, or any combination thereof. In some embodiments, the environmental condition comprising light comprises exposing the component to direct sunlight.

In some embodiments, the process effecting discoloration comprises exposing the component susceptible to discoloration to environmental conditions comprising high heat and high humidity. In some embodiments, the process effecting discoloration comprises exposing the component susceptible to discoloration to ambient environmental conditions of a room comprising intermediate heat and intermediate humidity. In some embodiments, the process effecting discoloration comprises exposing the component susceptible to discoloration to environmental conditions comprising low light and ambient environmental conditions of a room comprising intermediate heat and intermediate humidity. In some embodiments, the process effecting discoloration comprises exposing the component susceptible to discoloration to environmental conditions comprising high light and ambient environmental conditions of a room comprising intermediate heat and intermediate humidity.

In some embodiments, the process effecting discoloration comprises storing the component susceptible to discoloration in innate or native conditions. In some embodiments, the process effecting discoloration comprises exposing the component susceptible to discoloration to an environmental condition for a time selected from at least about one week, at least about two weeks, at least about three weeks, and at least about four weeks. In some embodiments, the process effecting discoloration comprises exposing the component susceptible to discoloration to an environmental condition for two weeks. In some embodiments, the process effecting discoloration comprises exposing the component susceptible to discoloration to an environmental condition for four weeks.

In some embodiments, the discoloration of the composition resistant to discoloration is reduced by at least 20% compared to the discoloration of the component susceptible to discoloration when exposed to similar conditions effecting discoloration. In some embodiments, the discoloration of the composition resistant to discoloration is reduced by at least 50% compared to the discoloration of the component susceptible to discoloration when exposed to similar conditions effecting discoloration. In some embodiments, the discoloration of the composition resistant to discoloration is reduced by at least 66% compared to the discoloration of the component susceptible to discoloration when exposed to similar conditions effecting discoloration.

In some embodiments, three-dimensional color spaces are selected from a CIE color space, a CIE XYZ color space, a CIE L*a*b color space, a CMYK color space, an RGB color space, the Munsell Color System, the Pantone Matching System, and the Natural Color System.

In some embodiments, the three-dimensional color space is a CIE L*a*b color space. A CIE L*a*b color space enables facile measurements and is commonly used in the paint and coatings industry to convey color changes and specifications

In some embodiments, three-dimensional color spaces are measured with an instrument selected from the group consisting of a tristimulus colorimeter, a spectroradiometer, a spectrophotometer, a spectrocolorimeter, a densitometer, a color temperature meter, and combinations thereof. In some embodiments, three-dimensional color spaces are measured with a Datacolor 500 spectrophotometer.

In some embodiments, three-dimensional color spaces are calculated with vector calculus. In some embodiments, a complimentary three-dimensional color space is determined by calculating the inverse vector to a reference three-dimensional color space.

In some embodiments, a complimentary three-dimensional color space is calculated according to Formula 1:

ΔE=\sqrt{(Lᵢ*−Lₓ*)²+(aᵢ−aₓ)²+(bᵢ*−bₓ*)²} (Formula 1),

where i is the initial color variable and x is the color variable after exposure.

Exemplary embodiments of this disclosure include, but are not limited to the following:

Embodiment 1. A composition resistant to discoloration, the composition comprising

a component susceptible to discoloration; and

a colorant component characterized by a three-dimensional color space that is complementary to the differences between a first three-dimensional color space of a reference component susceptible to discoloration and a second three-dimensional color space of the reference component susceptible to discoloration, wherein the second three-dimensional color space has been shifted from the first three-dimensional color space by a process effecting discoloration.

Embodiment 2. The composition of embodiment 1, wherein the component susceptible to discoloration is selected from the group consisting of colorless or pigmented sealants, clear or colorless sealants, brushable grade or self leveling sealants, colorless or pigmented caulks, colorless or pigmented adhesives, paints, coatings, and combinations thereof.

Embodiment 3. The composition of any of embodiments 1 or 2, wherein the colorant component comprises a colorant selected from the group consisting of dyes, pigments, and combinations thereof.

Embodiment 4. The composition of any of embodiments 1-3, wherein the colorant component comprises a black colorant.

Embodiment 5. The composition of any of embodiments 1-4, wherein the three-dimensional color space of the colorant component has non-zero values in at least two dimensions.

Embodiment 6. The composition of any of embodiments 1-5, wherein the process effecting discoloration effects discoloration in at least two dimensions of the three-dimensional color space.

Embodiment 7. The composition of any of embodiments 1-6, wherein the process effecting discoloration comprises exposing the component susceptible to discoloration to an environmental condition selected from the group consisting of light, heat, humidity, age, and combinations thereof.

Embodiment 8. The composition of any of embodiments 1-7, wherein the process effecting discoloration comprises exposing the component susceptible to discoloration to innate conditions.

Embodiment 9. The composition of any of embodiments 1-8, wherein the discoloration of the composition resistant to discoloration is reduced by at least 20% compared to the discoloration of the component susceptible to discoloration when exposed to similar conditions.

Embodiment 10. The composition of any of embodiments 1-9, wherein the discoloration of the composition resistant to discoloration is reduced by at least 50% compared to the discoloration of the component susceptible to discoloration when exposed to similar conditions.

Embodiment 11. A method of formulating a colorant component useful for producing a composition resistant to discoloration, the method comprising

measuring a reference three-dimensional color space of a reference component susceptible to discoloration;

effecting a shift in the reference three-dimensional color space of the reference component susceptible to discoloration;

measuring the shifted three-dimensional color space of the reference component susceptible to discoloration;

calculating the differences between the reference three-dimensional color space of the reference component susceptible to discoloration and the shifted three-dimensional color space of the reference component susceptible to discoloration;

calculating a three-dimensional color space complementary to the differences between the reference three-dimensional color space of the reference component susceptible to discoloration and the shifted three-dimensional color space of the reference component susceptible to discoloration; and

formulating a colorant component characterized by the three-dimensional color space complementary to the differences between the reference three-dimensional color space of the reference component susceptible to discoloration and the shifted three-dimensional color space of the reference component susceptible to discoloration.

Embodiment 12. The method of embodiment 11, wherein effecting a shift in the reference three-dimensional color space of the reference component susceptible to discoloration comprises exposing the reference component susceptible to discoloration to an environmental condition selected from the group consisting of light, heat, humidity, age, and combinations thereof.

Embodiment 13. The method of any of embodiments 11-12, wherein effecting a shift in the reference three-dimensional color space of the reference component susceptible to discoloration comprises exposing the reference component susceptible to discoloration to an environmental condition for at least two weeks.

Embodiment 14. The method of any of embodiments 11-13, wherein effecting a shift in the reference three-dimensional color space of the reference component susceptible to discoloration effects discoloration in at least two dimensions of the three-dimensional color space.

Embodiment 15. The method of any of embodiments 11-14, wherein the reference three-dimensional color space of the reference component susceptible to discoloration and the shifted three-dimensional color space of the reference component susceptible to discoloration are measured with an instrument selected from the group consisting of a tristimulus colorimeter, a spectroradiometer, a spectrophotometer, a spectrocolorimeter, a densitometer, a color temperature meter, and combinations thereof.

Embodiment 16. The method of any of embodiments 11-15, wherein the reference three-dimensional color space of the reference component susceptible to discoloration and the shifted three-dimensional color space of the reference component susceptible to discoloration are calculated with vector calculus.

Embodiment 17. A method of producing a composition resistant to discoloration, the method comprising forming a mixture comprising

a component susceptible to discoloration; and

a colorant component characterized by a three-dimensional color space that is complementary to the differences between a first three-dimensional color space of a reference component susceptible to discoloration and a second three-dimensional color space of the reference component susceptible to discoloration, wherein the second three-dimensional color space has been shifted from the first three-dimensional color space by a process effecting discoloration.

Embodiment 18. The method of embodiment 17, wherein the three-dimensional color space of the colorant component has non-zero values in at least two dimensions.

Embodiment 19. The method of any of embodiments 17-18, wherein the process effecting discoloration effects discoloration in at least two dimensions of the three-dimensional color space.

Embodiment 20. The method of any of embodiments 17-19, wherein the process effecting discoloration comprises exposing the component susceptible to discoloration to an environmental condition selected from the group consisting of light, heat, humidity, age, and combinations thereof.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever.

### Example 1. Method of Identifying a Three-Dimensional Color Space for Use in Reducing Discoloration

To identify a three-dimensional color space useful to reduce discoloration, wavelengths that caused a color shift with exposure of samples were first determined by exposing the samples to different environmental conditions that induced discoloration. These conditions are shown in Table 1 and vary from no environmental influence (dark conditions) to substantial environmental influence (small forma room conditions).

TABLE 1
Exposure environments to effect discoloration.

| Exposure Environment | Conditions |
|---|---|
| Dark | In a desk drawer at ambient temperature |
| Large Forma Room | 25° C. ± 2° C. and 50 ± 2% Relative Humidity |
| (LgF) | |
| Small Forma Room | 40° C. ± 2° C. and 90 ± 2% Relative Humidity |
| (SmF) | |
| Window | In a lab window sill at ambient temperature |

After appropriate conditions effecting discoloration were determined, and discoloration was observed as a result of those conditions, a dye composed of the complimentary color to the wavelength of observed discoloration was used to help reduce the appearance of discoloration. Complementary colors based on wavelength are shown in Table 2.

TABLE 2
Complimentary colors based on wavelength.

| Wavelength | | Complimentary |
|---|---|---|
| region | | color of the |
| eliminated | | residual light |
| by absorption | Color | (as seen by the |
| (nm) | absorbed | eye) |
| 400-450 | Violet | Yellow-green |
| 450-480 | Blue | Yellow |
| 480-490 | Green-blue | Orange |
| 490-500 | Blue-green | Red |
| 500-560 | Green | Purple |
| 560-580 | Yellow-green | Violet |
| 580-600 | Yellow | Blue |
| 600-650 | Orange | Green-blue |
| 650-750 | Red | Blue-green |

### Example 2. Pigmented Formulation

Pigmented sealants are known to yellow with exposure. Pigmented sealants were evaluated according to the method of Example 1. Each sealant sample was cured for 3-7 days. Upon full cure it was measured for its initial color values and then exposed to the different environmental conditions shown in Table 1 and measured weekly.

On the basis of these results, a black colorant and a violet dye were added to a new white sealant formulation. These colorants are in contrast to the conventional methods where blue was added and only made the yellow turn green. The black colorant completely shifted the three-dimensional color space of that system. Using a DataColor 500 spectrophotometer running on Datacolor Tools software, color was measured in a three-dimensional color space, where the b* value is representative of the yellow blue axis, a* is the red green axis, and L* is the black white axis. A representative color space is shown in FIG. 1. Using the four different environments of exposure shown in Table 1, the change in appearance of yellowing was measured with time. As shown in FIG. 2 and Table 3, yellowing was reduced over time and especially after four weeks.

TABLE 3
Reduction in discoloration of a white formulation.

| | | | Percent |
|---|---|---|---|
| | | | Reduced |
| Condition | Current b* | Proposed b* | (%) |
| Dark | 5.59 | 3.58 | 36 |
| Lg Forma | 6.00 | 3.28 | 45 |
| Sm Forma | 6.66 | 5.29 | 21 |
| Window | 5.39 | 0.95 | 82 |

Current b* is the b* value (yellow blue axis of the 3 dimensional color space) and shows the b* value after 4 weeks of aging in the defined conditions. Proposed b* shows the b* values for the proposed reformulation that uses the violet dye at the same time in the same conditions of exposure to reduce discoloration.

### Example 3. Clear Formulation

Clear sealants are known to yellow with exposure. Clear sealants were evaluated according to the method of Example 1. Each sealant sample was cured for 3-7 days. Upon full cure it was measured for its initial color values and then exposed to the different environmental conditions shown in Table 1 and measured weekly.

On the basis of the results, a violet dye was added to a new clear sealant formulation. This colorant is in contrast to the conventional methods where blue was added and only made the yellow turn green. Using a DataColor 500 spectrophotometer running on Datacolor Tools software, color was measured in a three-dimensional color space, where the b* value is representative of the yellow blue axis, a* is the red green axis, and L* is the black white axis. Using the four different environments of exposure shown in Table 1, the change in appearance of yellowing was measured with time. As shown in FIG. 3 and Table 4, yellowing was reduced over time and especially after four weeks.

TABLE 4
Reduction in discoloration of a clear formulation.

| | | | Percent |
|---|---|---|---|
| | | | Reduced |
| Condition | Current b* | Proposed b* | (%) |
| Dark | 5.54 | 1.36 | 75 |
| Lg Forma | 5.49 | 1.87 | 66 |
| Sm Forma | 7.14 | 2.17 | 70 |
| Window | 2.69 | 1.17 | 57 |

Current b* is the b* value (yellow blue axis of the 3 dimensional color space) and shows the b* value after 4 weeks of aging in the defined conditions. Proposed b* shows the b* values for the proposed reformulation that uses the violet dye at the same time in the same conditions of exposure to reduce discoloration.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A composition resistant to discoloration, the composition comprising
a component susceptible to discoloration; and
a colorant component characterized by a three-dimensional color space that is complementary to the differences between a first three-dimensional color space of a reference component susceptible to discoloration and a second three-dimensional color space of the reference component susceptible to discoloration, wherein the second three-dimensional color space has been shifted from the first three-dimensional color space by a process effecting discoloration.

2. The composition of claim 1, wherein the component susceptible to discoloration is selected from the group consisting of colorless or pigmented sealants, clear or colorless sealants, brushable grade or self leveling sealants, colorless or pigmented caulks, colorless or pigmented adhesives, paints, coatings, and combinations thereof.

3. The composition of claim 1, wherein the colorant component comprises a colorant selected from the group consisting of dyes, pigments, and combinations thereof.

4. The composition of claim 1, wherein the colorant component comprises a black colorant.

5. The composition of claim 1, wherein the three-dimensional color space of the colorant component has non-zero values in at least two dimensions.

6. The composition of claim 1, wherein the process effecting discoloration effects discoloration in at least two dimensions of the three-dimensional color space.

7. The composition of claim 1, wherein the process effecting discoloration comprises exposing the component susceptible to discoloration to an environmental condition selected from the group consisting of light, heat, humidity, age, and combinations thereof.

8. The composition of claim 1, wherein the process effecting discoloration comprises exposing the component susceptible to discoloration to innate conditions.

9. The composition of claim 1, wherein the discoloration of the composition resistant to discoloration is reduced by at least 20% compared to the discoloration of the component susceptible to discoloration when exposed to similar conditions.

10. The composition of claim 1, wherein the discoloration of the composition resistant to discoloration is reduced by at least 50% compared to the discoloration of the component susceptible to discoloration when exposed to similar conditions.

11. A method of formulating a colorant component useful for producing a composition resistant to discoloration, the method comprising
measuring a reference three-dimensional color space of a reference component susceptible to discoloration;
effecting a shift in the reference three-dimensional color space of the reference component susceptible to discoloration;
measuring the shifted three-dimensional color space of the reference component susceptible to discoloration;
calculating the differences between the reference three-dimensional color space of the reference component susceptible to discoloration and the shifted three-dimensional color space of the reference component susceptible to discoloration;
calculating a three-dimensional color space complementary to the differences between the reference three-dimensional color space of the reference component susceptible to discoloration and the shifted three-dimensional color space of the reference component susceptible to discoloration; and
formulating a colorant component characterized by the three-dimensional color space complementary to the differences between the reference three-dimensional color space of the reference component susceptible to discoloration and the shifted three-dimensional color space of the reference component susceptible to discoloration.

12. The method of claim 11, wherein effecting a shift in the reference three-dimensional color space of the reference component susceptible to discoloration comprises exposing the reference component susceptible to discoloration to an environmental condition selected from the group consisting of light, heat, humidity, age, and combinations thereof.

13. The method of claim 11, wherein effecting a shift in the reference three-dimensional color space of the reference component susceptible to discoloration comprises exposing the reference component susceptible to discoloration to an environmental condition for at least two weeks

14. The method of claim 11, wherein effecting a shift in the reference three-dimensional color space of the reference component susceptible to discoloration effects discoloration in at least two dimensions of the three-dimensional color space.

15. The method of claim 11, wherein the reference three-dimensional color space of the reference component susceptible to discoloration and the shifted three-dimensional color space of the reference component susceptible to discoloration are measured with an instrument selected from the group consisting of a tristimulus colorimeter, a spectroradiometer, a spectrophotometer, a spectrocolorimeter, a densitometer, a color temperature meter, and combinations thereof.

16. The method of claim 11, wherein the reference three-dimensional color space of the reference component susceptible to discoloration and the shifted three-dimensional color space of the reference component susceptible to discoloration are calculated with vector calculus.

17. A method of producing a composition resistant to discoloration, the method comprising forming a mixture comprising
a component susceptible to discoloration; and
a colorant component characterized by a three-dimensional color space that is complementary to the differences between a first three-dimensional color space of a reference component susceptible to discoloration and a second three-dimensional color space of the reference component susceptible to discoloration, wherein the second three-dimensional color space has been shifted from the first three-dimensional color space by a process effecting discoloration.

18. The method of claim 17, wherein the three-dimensional color space of the colorant component has non-zero values in at least two dimensions.

19. The method of claim 17, wherein the process effecting discoloration effects discoloration in at least two dimensions of the three-dimensional color space.

20. The method of claim 17, wherein the process effecting discoloration comprises exposing the component susceptible to discoloration to an environmental condition selected from the group consisting of light, heat, humidity, age, and combinations thereof.
